(19) United States
(12) Patent Application Publication
(10) Pub. No.: US 2005/0074729 A1
(43) Pub. Date: Apr. 7, 2005

(54) Limb function training apparatus and method

(76) Inventor: Masakuni Aramaki, Shimokita-gun (JP)

Correspondence Address: HAUPTMAN KANESAKA BERNER PATENT AGENTS, SUITE 300, 1700 DIAGONAL RD, ALEXANDRIA, VA, 22314-2848, US

(21) Appl. No.: 10/988,503

(22) Filed: Nov. 16, 2004

Related U.S. Application Data
(63) Continuation of application No. 10/173,314, filed on Jun. 18, 2002.

(30) Foreign Application Priority Data
Jun. 22, 2001 (JP) 2001-189263

(51) Int. Cl. A63B 24/00; G09B 19/06; G09B 19/08

(52) U.S. Cl. 434/157

(57) ABSTRACT

A limb function training method includes the steps of using a walking training apparatus having a visually recognized member with a visually recognized surface on which a limb function trainee can walk. The visually recognized surface has a meshed pattern by arranging squares having the same area in a matrix form and coloring each square in a color different from a color of the adjacent square such as white and black. The limb function trainee walks on the limb function training apparatus while visually recognizing the meshed pattern of the visually recognized surface.

### CROSS REFERENCE TO RELATED APPLICATION

This is a continuation application of a patent application Ser. No. 10/173,314 filed on Jun. 18, 2002.

### BACKGROUND OF THE INVENTION AND RELATED ART STATEMENT

The present invention relates to a limb function training apparatus and method intended for those who have disorders in limb functions of upper and lower limbs, for example, because of aging, diseases, accidents, and the like, and developed to recover/train limb functions.

In general, there are a large number of people who have difficulties in limbs because of aging, brain disorders such as infarction and apoplexy, Parkinson's disease, injuries by traffic accidents, and other causes. These people have various trainings, so-called rehabilitations in order to recover and improve limb functions. Examples of the trainings of lower limbs include physical therapy, walking trainings with the help of attendants or various training machines.

Additionally, in the various trainings, so-called rehabilitations, in general, muscular strength trainings are mainly carried out, and are accompanied by physical or mental pains in many cases, and recovery with a good efficiency cannot necessarily be achieved in actual conditions.

### SUMMARY OF THE INVENTION

The present has been developed in consideration of the above-described problems, and an object thereof is to provide a limb function training apparatus and method in which physical and mental pains are caused as little as possible, a limb function can naturally be enhanced, and a recovery efficiency of the limb function is improved.

To achieve this object, according to the present invention, there is provided a limb function training apparatus comprising: a visually recognized member including a visually recognized surface visually recognized by a limb function trainee while moving a limb, wherein a meshed pattern in which figures are regularly arranged and the respective figures are regularly color-coded is attached to the visually recognized surface of the visually recognized member.

Moreover, in the limb function training apparatus of the present invention, the meshed pattern in which squares having the same area are arranged in a matrix form and each square is colored in a color different from a color of the adjacent square, such as any one of white and black is attached to the visually recognized surface of the visually recognized member.

When a limb function training is carried out using this limb function training apparatus, the limb function trainee's limbs are moved by themselves, or using an assistant or an assisting tool. In this case, the limb function trainee exercises while visually recognizing the meshed pattern of the visually recognized surface. Thereby, the recovery of the limb function is promoted. For example, a person who has been incapable of walking can walk, or a person can walk at a speed several times faster than a previous speed.

When the meshed pattern having alternately varying colors is visually recognized, a peculiar stimulate is generated in the brain through a visual sense. This action of visual system feedback activates a command from the brain concerning the limbs to move, an intention to positively walk increases, and this supposedly brings about a satisfactory action in the limb function.

In this case, when each square is colored in a color different from a color of the adjacent square, such as any one of white and black, the satisfactory action is securely brought about in the limb function.

As a result, the physical and mental pains are caused as little as possible, the limb function can naturally be enhanced, and the recovery efficiency of the limb function can be improved. Moreover, in the limb function training apparatus of the present invention, a size S of one side of the square is set to a range of 5 mm≦S≦700 mm. Preferably, it is effective to set the size S of one side of the square to a range of 10 mm≦S≦30 mm. In this size range, the satisfactory action is securely brought about in the limb function.

Moreover, in the limb function training apparatus of the present invention, the visually recognized member is formed such that the limb function trainee can walk on the visually recognized surface. The physical and mental pains are caused as little as possible, a walking function can naturally be enhanced, and the recovery efficiency of the walking function can be improved.

In this case, it is effective to form the visually recognized member of a sheet-shaped member. When the member is formed of the sheet-shaped member, it is easy to install the member. It is possible to spread and use the member if necessary, it is also easy to store and handle the member, and general-purpose properties increase. Moreover, in this case, the visually recognized member is formed of a rollable sheet-shaped member which has a width D of 0.5 m≦D≦2 m, and a length L of 3 m or more. In this case, it is easy to roll up and store the member, it is further easier to handle the member, and the general-purpose properties increase.

Moreover, in the limb function training apparatus of the present invention, the visually recognized member is formed to be attachable to the limb to be moved by the limb function trainee. In this case, the physical and mental pains are caused as little as possible, the limb function can naturally be enhanced, and the recovery efficiency of the limb function can be improved.

In this case, the visually recognized member is formed in a bag shape such that the member is closely attached to the limb and the limb is covered with the member. Then, the attaching is facilitated.

To achieve the above-described object, according to the present invention, there is provided a limb function training method comprising the steps of: using a limb function training apparatus comprising a visually recognized member having a visually recognized surface on which a limb function trainee walks and in which a meshed pattern is formed by regularly arranging figures and regularly color-coding the respective figures; and allowing the limb function trainee to walk while visually recognizing the meshed pattern of the visually recognized surface.

Moreover, according to another aspect of the present invention, there is provided a limb function training method comprising the steps of: using a limb function training apparatus comprising a visually recognized member formed to be attachable to a limb to be moved by a limb function trainee and having a visually recognized surface which can visually be recognized by the limb function trainee and in which a meshed pattern is formed by regularly arranging figures and regularly color-coding the respective figures; and attaching the apparatus to the limb to be moved by the limb function trainee and moving the limb while visually recognizing the meshed pattern of the visually recognized surface.

Furthermore, according to still another aspect of the present invention, there is provided a limb function training method comprising the steps of: using a limb function training apparatus comprising a visually recognized member formed to be attachable to a limb to be moved by a limb function trainee and having a visually recognized surface which can visually be recognized by the limb function trainee and in which a meshed pattern is formed by arranging squares having the same area in a matrix form and coloring each figure in a color different from a color of the adjacent square, such as any one of white and black; and attaching the apparatus to the limb of the limb function trainee to be moved and moving the limb while visually recognizing the meshed pattern of the visually recognized surface.

Even these limb function training methods produce effects similar to those of the apparatus according to the present invention.

### BRIEF DESCRIPTION OF THE DRAWINGS

FIG. 1 is a perspective view of a limb function training apparatus in a use state thereof according to a first embodiment of the present invention.

FIG. 2 is a diagram showing a main part of the limb function training apparatus according to the first embodiment of the present invention.

FIG. 3 is a perspective view of the limb function training apparatus in the use state thereof according to second and third embodiments of the present invention.

### BEST MODE OF CARRYING OUT THE INVENTION

A limb function training apparatus and method according to embodiments of the present invention will be described hereinafter in detail with reference to the accompanying drawings. Additionally, the scope of the present invention is not limited to the embodiments.

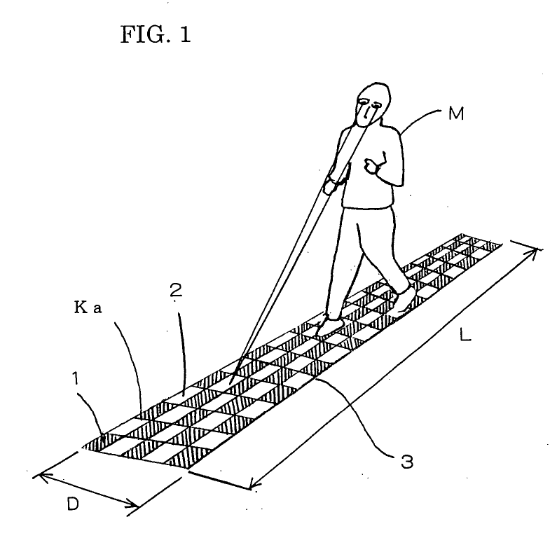

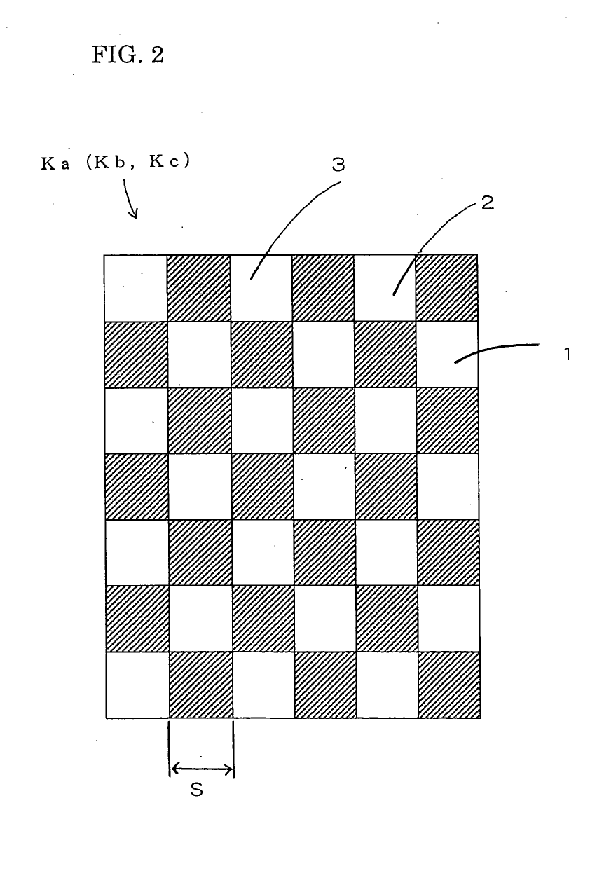

FIGS. 1 and 2 show a limb function training apparatus Ka according to a first embodiment. The limb function training apparatus Ka includes a visually recognized member 1 having a visually recognized surface 2 on which a limb function trainee M can walk. This visually recognized member 1 is formed of a rollable sheet-shaped material which has a width D in a range of 0.5 m≦D≦2 m, and a length L of 3 m or more. Examples of the material include appropriate materials such as a resin and paper. In the embodiment, the sizes are set to D=0.7 m, L=10 m. In an unused time, the member is rolled up and stored.

Moreover, a meshed pattern 3 is attached to the visually recognized surface 2 of the visually recognized member 1, and formed by regularly arranging figures and regularly color-coding the respective figures. In detail, the meshed pattern 3 attached to the visually recognized surface 2 is a grid form (so-called “checkered pattern”) in which squares having the same area are arranged in a matrix form and each square is colored in a color different from a color of the adjacent square, such as any one color of white and black. For a direction of the square, one pair of sides parallel to each other extend along a longitudinal direction (walking direction) of the visually recognized member 1, and the other pair of sides formed at right angles to the one pair of sides are set to extend along a width direction of the visually recognized member 1.

Furthermore, a size S of one side of the square is set to a range of 5 mm≦S≦700 mm, preferably 10 mm≦S≦30 mm. In the first embodiment, the size is set to S=20 mm.

Therefore, when the limb function training apparatus Ka according to the first embodiment is used to carry out a walking training (limb function training method), first the rolled apparatus Ka is unrolled, and laid in a room. In this case, the apparatus is only unrolled and can therefore easily be installed.

In this state, the walking training is performed. In this case, the limb function trainee M is allowed to walk on the visually recognized surface 2 of the visually recognized member 1 by trainee's own efforts, or with an assistant or an assisting tool. In this case, the limb function trainee M is allowed to walk while visually recognizing the meshed pattern 3 of the visually recognized surface 2. Thereby, when the meshed pattern 3 having alternately varying colors is visually recognized, a peculiar stimulate is generated in the brain through a visual sense. This action of visual system feedback activates a command from the brain concerning the walking, and an intention to positively walk is considered to increase.

As a result, the recovery of a walking function is promoted. For example, a person who has been incapable of walking can walk, or a person can walk at a speed several times faster than a previous speed, and other effects are produced. In this case, when each square is colored in a color different from that of the adjacent square, such as any one of white and black, a satisfactory action is securely brought about in the walking function.

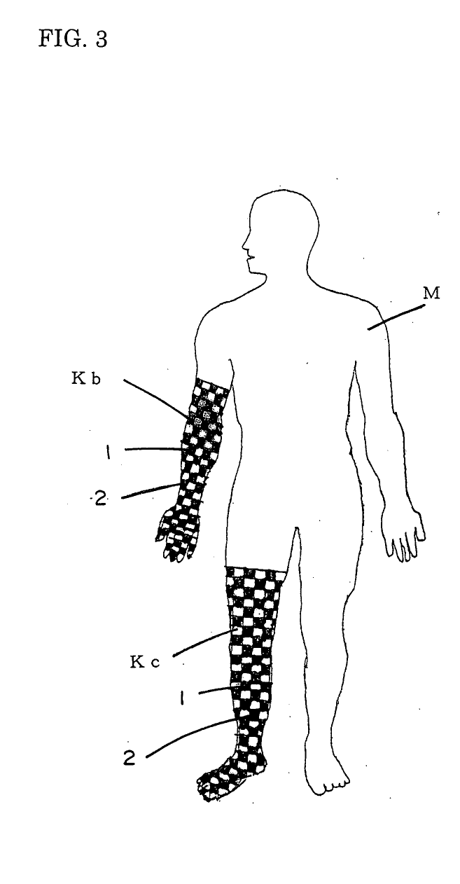

FIG. 3 shows a limb function training apparatus Kb according to a second embodiment. The limb function training apparatus Kb is formed to be attachable to an upper limb as the limb to be moved by the limb function trainee M. In detail, the visually recognized member 1 is formed in a bag shape which is attached to the upper limb and with which the limb is covered, that is, formed in a long glove shape extending up to an arm. Examples of the material include appropriate materials such as cloth, rubber, and resin sheet.

Moreover, the meshed pattern 3 formed by regularly arranging the figures and regularly color-coding the respective figures is attached to the visually recognized surface 2 of the visually recognized member 1. In detail, the meshed pattern 3 attached to the visually recognized surface 2 is a grid form (so-called “checkered pattern”) in which the squares having the same area are arranged in a matrix form and each square is colored in the color different from that of the adjacent square, such as any one color of white and black.

Furthermore, as shown in FIG. 2, the size S of one side of the square is set to a range of preferably 10 mm≦S≦30 mm. In the second embodiment, the size is set to S=10 mm.

Therefore, when the limb function training apparatus Kb according to the second embodiment is used to perform an upper limb function training as the limb function training, first the upper limb is covered with the present apparatus Kb similarly as in pulling up a glove.

In this state, the upper limb is bent, moved up and down, rotated, or moved otherwise. Also in this case, for the same reason as above, the recovery of an upper limb exercise function is promoted. For example, a person who has been incapable of moving the upper limb can move the limb, or a person can exercise at the speed several times faster than the previous speed, and other effects are produced. In this case, when each square is colored in the color different from that of the adjacent square, such as any one of white and black, the satisfactory action is securely brought about in the upper limb function.

Moreover, FIG. 3 shows a limb function training apparatus Kc according to a third embodiment. The limb function training apparatus Kc is formed to be attachable to a lower limb as the limb to be moved by the limb function trainee M. In detail, the visually recognized member 1 is formed in the bag shape which is closely attached to the lower limb and with which the limb is covered, that is, formed in a long sock shape extending up to a thigh. Examples of the material include appropriate materials such as cloth, rubber, and resin sheet.

Therefore, when the limb function training apparatus Kc according to the third embodiment is used to perform a lower limb function training as the limb function training, first the lower limb is covered with the present apparatus Kc similarly as in pulling up a sock.

In this state, the lower limb is bent, moved up and down, or rotated. Alternatively, exercises such as the walking are performed. In this case, the limb function trainee M is allowed to exercise while visually recognizing the meshed pattern 3 of the visually recognized surface 2. Also in this case, for the same reason as above, the recovery of a lower limb exercise function is promoted. For example, a person who has been incapable of moving the lower limb can move the limb, a person who has been incapable of walking can now walk, or a person can walk at the speed several times faster than the previous speed, and other effects are produced.

### TEST EXAMPLES

The limb function training apparatus Ka according to the first embodiment was used, and several tens of people who have difficulties in walking because of Parkinson's disease were subjected to a walking training test. In any case, a person who had not been capable of walking could walk, another person could walk at the speed several times (twice to five times) faster than the previous speed, and at least an effect of recovery of the walking function appeared.

Tests conducted using the limb function training apparatuses Kb, Kc according to the second and third embodiments will next be described.

Several tens of patients each having paralysis in four limbs because of apoplexy were subjected to a limb training test using the limb function training apparatus. In general, the person who developed apoplexy but escaped death is expected to be cured toward a precritical body condition. However, this is not allowed by “paralysis” in case of apoplexy. For this disease having a developed peak in 60's, the patient is forced to have a life with the paralysis for ten years or more left. In a modern rehabilitation medical science, there is not an idea that the paralysis itself is eliminated, and efforts to extend a capability the patient still has and to improve environments have been developed in the present conditions.

The test was carried out as follows. The glove-shaped limb function training apparatus having a pattern similar to the pattern of the embodiment was attached to a patient's paralyzed limb, and the patient was requested to carefully watch the apparatus and to first recognize the patient's own limb. Then, the limb was moved up and down, and finally fingers/toes were bent. Usually, when the patient forcibly moves the paralyzed limb, the patient experiences pains. However, the above-described method is not accompanied by pains, and the patient feels that the patient's own limb moves.

As a result, after the glove-shaped apparatuses were detached from the patients, 60 to 70% of the patients could move their own limbs and recover, or a remarkable improvement was seen.

In this case, when this training method was performed immediately after entering a period of stability of the developed disease, the prognosis was improved. In experiments conducted with respect to the patients who were given conventional rehabilitation trainings in the period of stability several years ago, they could move their limbs at the speed twice to three times faster than the previous speed, but the bending and movement of the limbs were awkward probably because of muscular atrophy and joint contracture. Nevertheless, after the training, the limbs were apparently warmer than before the training (the paralyzed limbs are usually cold). Moreover, when asked about the feeling, the patients commented that they felt some stir and had new feelings.

Considered reasons for this will next be described. The paralysis caused by apoplexy is said to be a learned paralysis. In detail, the reason why the limbs are really paralyzed by apoplexy is that a brain blood vessel is clogged, then a nerve fiber extending down to a spinal cord from a frontal region of brain is disordered by a lack of oxygen, and the arm or leg is paralyzed. However, in an initial stage of apoplexy, the brain expands, a part of the nerve is temporarily dead, but other nerves literally faint, and are left in a so-called “off-line”. While the arms or legs do not function, the brain is supposed to receive a visual feedback indicating “the arm does not move”. Moreover, even after the brain stops expanding, the patient's brain possibly remains in a learned paralyzed state. This is why the paralysis is called the learned paralysis.

Therefore, during the attaching of the apparatuses according to the present invention to the limbs, the patients need to be persuaded to admit that the limbs are their own limbs. They think that the paralyzed arms or legs are not their own arms or legs. Therefore, when the patients see the patterns attached to the paralyzed arms or legs, the visual feedback is caused, and the patients can supposedly be cured.

In principle, the method is intended for apoplexy patients, but the present method seems to be an effective medical treatment even for aged people with limbs paralyzed, and limb shakiness by dementia and Parkinson's disease. Additionally, the present method seems to be effective even for anorexia. Moreover, it is preferable to carry out the training method immediately after the disease is developed. If the method is carried out later, muscles and joints are disordered and the rehabilitation does not work. Furthermore, the present method is also effective for those who have eating disorder/swallowing difficulty. With the attachment of the present apparatus, drinking and eating are smoothly achieved.

The rehabilitation has heretofore been a symptomatic therapy. However, the training method using the present apparatus seems to be a radical treatment.

Additionally, in the above-described embodiments, the meshed pattern 3 is constituted by arranging the squares in a matrix form, but the constitution is not limited to this. Examples of the figure include a circle, regular triangle, parallelogram, and hexagon. Each type of figure is used alone or combined with other types of figures, the figures for use may regularly be arranged, and this figure constitution may appropriately be changed. Moreover, the color-coding is not limited to two colors, and three or more colors may be used as long as the color-coding is regular.

Furthermore, in the embodiments, the squares are colored in white and black, but this is not limited, and the squares may of course be colored in various colors.

Additionally, the form of the visually recognized member 1 according to the first embodiment is not limited to the above-described form, and may also be constituted of appropriate members such as a carpet and floor per se.

1. A limb function training apparatus comprising:
a visually recognized member including a visually recognized surface visually recognized by a limb function trainee while the limb function trainee moves a limb, said visually recognized surface including a meshed pattern having squares with a same area arranged in a matrix form, each square having a color different from a color of an adjacent square.

2. The limb function training apparatus according to claim 1, wherein white and black are attached to the visually recognized surface of the visually recognized member.

3. The limb function training apparatus according to claim 1, wherein said square has a side S in a range of 5 mm≦S≦700 mm.

4. The limb function training apparatus according to claim 1, wherein said square has a side S in a range of 10 mm≦S≦30 mm.

5. The limb function training apparatus according to claim 1, wherein said visually recognized member is formed such that the limb function trainee can walk on the visually recognized surface.

6. The limb function training apparatus according to claim 5, wherein said visually recognized member is formed of a sheet-shaped member.

7. The limb function training apparatus according to claim 6, wherein said sheet-shaped member has a width D of 0.5 m≦D≦2 m, and a length of 3 m or more.

8. A limb function training method comprising the steps of:
using a limb function training apparatus comprising a visually recognized member having a visually recognized surface on which a limb function trainee can walk and in which a meshed pattern is formed by arranging squares having a same area in a matrix form and coloring each of the squares in a color different from a color of the adjacent square including white and black; and
allowing the limb function trainee to walk while visually recognizing the meshed pattern of said visually recognized surface.
